(19) United States
(12) Patent Application Publication
(10) Pub. No.: US 2004/0132396 A1
(43) Pub. Date: Jul. 8, 2004

(54) Accessory for making patties from a vacuum filling machine

(76) Inventor: Martin Gallant, St-Mathieu (CA)

Correspondence Address: INVENTARIUM, #1607, 4050 Rosemont blvd, Montreal, QC, H1X 1M4, CA

(21) Appl. No.: 10/703,134

(22) Filed: Nov. 6, 2003

Related U.S. Application Data
(60) Provisional application No. 60/425,010, filed on Nov. 8, 2002.

(51) Int. Cl. A22C 18/00

(52) U.S. Cl. 452/175

(57) ABSTRACT

An accessory for making patties from a vacuum filling machine uses a back and fro bidirectional sliding motion which alternately presents two or more openings to an output from a vacuum filling machine. In its simplest form, as a first opening is filled and a patty is shaped, simultaneously, in a second opening, a previously made patty is pushed out and the second opening thus liberated is slid back underneath the output from the vacuum filling machine to be filled while at the same time the first opening is emptied and then slid back underneath the output of the cacuum filling machine and so on. This unique simultaneous filling and emptying produces twice the yield that could be expected from a machine of a similar size.

Applicant claims priority based on provisional application 60/425,010 filed Nov. 8, 2002

### BACKGROUND OF THE INVENTION

1. Field of the Invention

This invention relates generally to vacuum filling or stuffing machines for food preparation but more particularly to an extension accessory for such machines which can make patties or such related flat shaped foodstuff.

2. Background

Machines that make patties, mostly for hamburgers, are usually very big and expensive. There are also some smaller scale machines that make patties but they are not very fast and are still relatively costly. Accordingly, a need remains for a need for a fast efficient machine that can yield a large amount of patties in a short amount of time.

### SUMMARY OF THE INVENTION

One object of the present invention is to provide for a small and portable machine for making patties or such related flat shaped foodstuff.

A second object is to provide a machine that can be connected directly to a vacuum filling machine as an accessory.

A third object is to provide a machine that has considerably more yield than conventional machines of the same size/price range.

A fourth object is to provide a machine that is simple and fast to setup.

In order to do so, the invention uses a back and fro bidirectional sliding motion which alternately presents two or more openings to an output from a vacuum filling machine. In its simplest form, as a first opening is filled and a patty is shaped, simultaneously, in a second opening, a previously made patty is pushed out and the second opening thus liberated is slid back underneath the output from the vacuum filling machine to be filled while at the same time the first opening is emptied and then slid back underneath the output of the cacuum filling machine and so on. This unique simultaneous filling and emptying produces twice the yield that could be expected from a machine of a similar size.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE PREFERRED EMBODIMENT

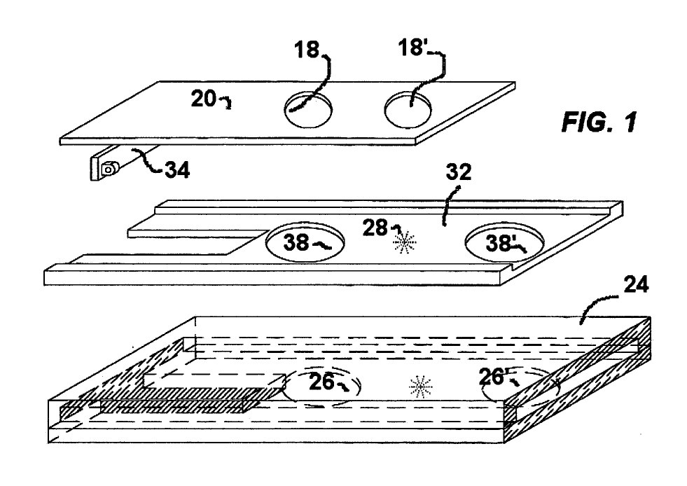

FIG. 1 Is an isometric elevational view of three components: guillotine, spacer, and frame.

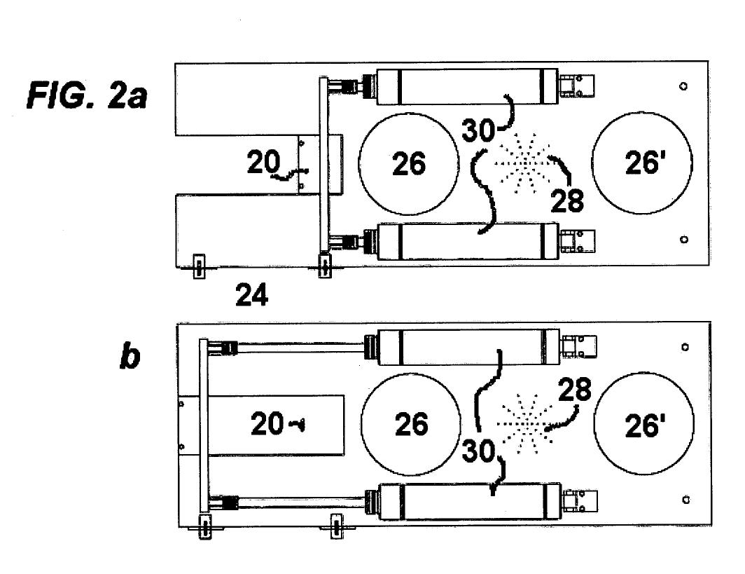

FIGS. 2ab Side elevational views showing the two basic positions of the guillotine and related components in general.

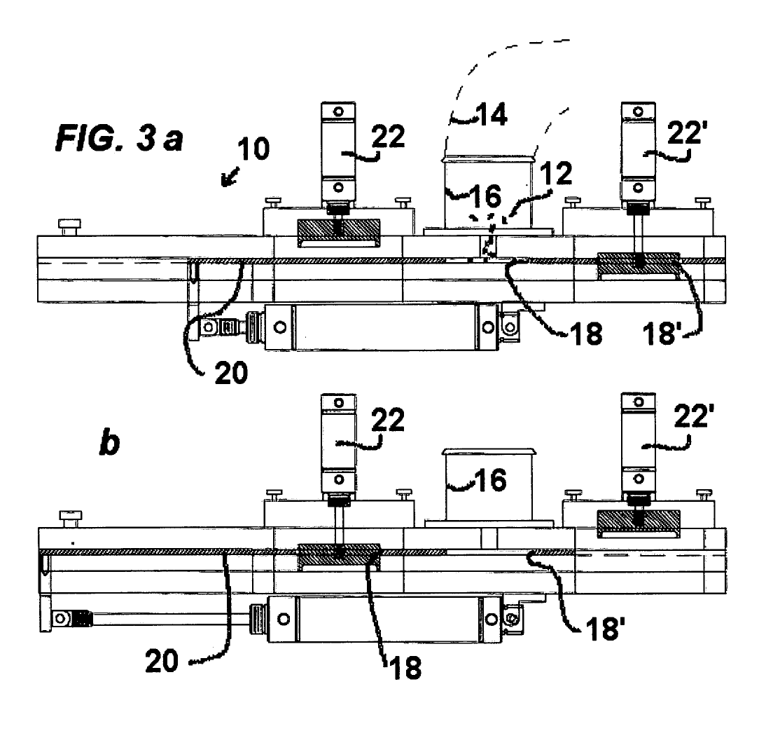

FIGS. 3ab Bottom elevational view showing the two exit holes as well as an air exit grille along with the two basic positions of the push pull mechanism.

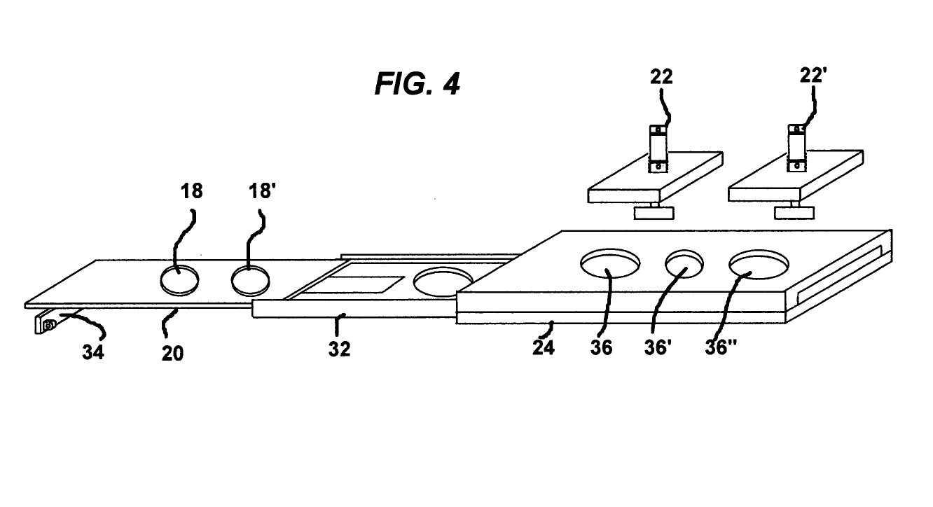

FIG. 4 Is an isometric elevational view of three components of FIG. 3 in their common relationship and with the added push out pistons.

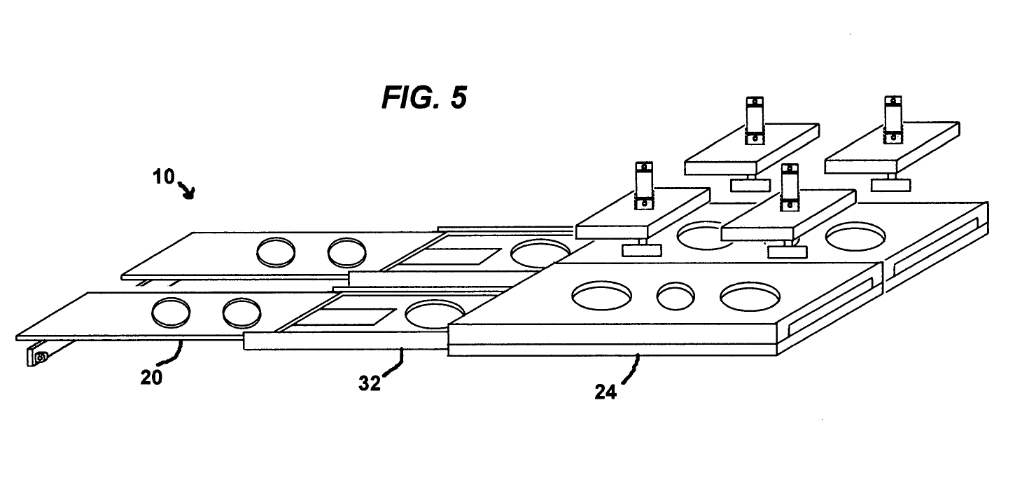

FIG. 5 Is an alternate embodiment showing expandability.

### DETAILED DESCRIPTION OF THE PREFERRED EMBODIMENT

FIG. 1 In order to better understand the workings of an accessory for making patties from a vacuum filling machine (10), there are three basic elements which are: A guillotine (20), a spacer (32) and a frame (24). Both the guillotine (20) and the spacer (32) are placed inside of the frame (24). The function of the spacer (32) is strictly to allow for a variety of guillotines (20) of different thicknesses. In other words, the sum of the thickness of both the guillotine (20) and the spacer (32) should always be equal to the space available inside of the frame (24). A flat bar (34) connects a push pull means (30) to the guillotine (20). Passage holes (38, 38′) act as interface between empty shapes (18, 18′) and exit holes (26, 26′) to allow pass through of foodstuff (12) as seen in

FIG. 2ab where the foodstuff (12) is received from an exit horn (14) (ghost lines) of a vacuum filling machine (not shown) into an injection head (16). From the injection head (16), the foodstuff (12) is forced into the empty shape (18). In FIG. 2b, once the empty shape (18) is filled with the foodstuff (12), the guillotine (20) slides to the left (in the figure) until the empty shape (18), which was underneath the injection head (16) in FIG. 2a is now below a push out piston (22). The push out piston (22) pushes the foodstuff (12) while at the same time, another empty shape (18′), now under the injection head (16), is being filled with foodstuff (12). Since two concurrent steps occur, that is the making of a patty along with the exiting of a patty, the accessory (10) can produce twice as much patties as a traditional one step at a time machine.

FIG. 3ab The frame (24) has two exit holes (26, 26′) through which the foodstuff (12) (not shown) exits. In between these two exit holes (26, 26′) is an air exit grille (28) which is necessary to allow the foodstuff (12) (not shown) to fill the empty shapes (18 or 18′) and avoid air pockets. A push pull means (30) provides motion to the guillotine (20) which, in this view, is mostly hidden by the frame (24). Although hydraulic pistons are currently the favored means of executing the back and fro motion of the guillotine (20) for various reasons such as speed, sanitation, low cost and overall durability, the use of such pistons as push pull means is shown here strictly as an example and should not be construed as limiting since future developments of existing or yet to come means may render such a means obsolete.

FIG. 4 Shows the insertion of the guillotine (20) and of the spacer (32) into the inside of the frame (24). On top of the frame (24) can be seen three entry holes (36, 36′ and 36″) where entry holes (36 and 36″) are to allow the passage of the push out pistons (22, 22′) to the empty shapes (18, 18′) and entry hole (36′) is for the passage of the foodstuff (12) (not shown).

FIG. 5 Although previous illustrations have shown 2 empty shapes (18, 18′) and two push out pistons (22, 22′), it should be understood that a vacuum filling machine can have split exit horns (14) that can feed more than a single injection head (16) at once and it is therefore easy to increase the capacity of the accessory for making patties from a vacuum filling machine (10) by either placing more than one unit side by side or by making larger components such as a larger guillotine (20), spacer (32) and frame (24) so that the result gives the equivalent of 2 or more side by side accessory for making patties from a vacuum filling machine (10).

1. An accessory for making patties from a vacuum filling machine comprising:
a guillotine, a spacer, a frame, and a push out piston;
said guillotine and said spacer usually positioned inside said frame;
a flat bar connecting a push pull means to said guillotine;
an injection head to inject foodstuff into an empty shape made into said frame;
passage holes made into said guillotine interfacing between said empty shape and said exit holes situated on the bottom side underneath said frame so as to allow pass through of said foodstuff;
push pull means to provide motion to said guillotine;
a plurality of entry holes wherein at least two are to allow passage of said push out pistons to said empty spaces while at least one hole being for the passage of said foodstuff.

2. An accessory for making patties from a vacuum filling machine as in claim 1 further comprising:
an air exit grille so as to avoid air pockets when filling said empty shape with said foodstuff.

3. An accessory for making patties from a vacuum filling machine as in claim 1 wherein: said push pull means being hydraulic pistons.

4. An accessory for making patties from a vacuum filling machine having the folowing method of operation:
said injection head receives said foodstuff and from said injection head said foodstuff being forced into said empty shape;
once said empty shape is filled with said foodstuff, said guillotine slides in one direction until said empty shape, which was previously underneath said injection head, now being below said push out piston and said said push out piston pushing out said foodstuff while simultaneously, a second empty space is being filled with said foodstuff from said injection head.
